(19) United States
(12) Patent Application Publication
(10) Pub. No.: US 2024/0311445 A1
(43) Pub. Date: Sep. 19, 2024

(54) Method and Apparatus for Evaluating Similarity Between Files

(71) Applicant: Crowdstrike, Inc., Sunnyvale, CA (US)

(72) Inventor: Michael Slawinski, Rancho Santa Margarita, CA (US)

(21) Appl. No.: 18/183,882

(22) Filed: Mar. 14, 2023

(51) Int. Cl. G06F 18/2415; G06F 16/16

(52) U.S. Cl. CPC G06F 18/2415; G06F 16/16

(57) ABSTRACT

A method for constructing a similarity space in which to compare files. The method receives, and creates a respective pair of feature vectors for, each of the files. A low-level feature vector is created for a file, via a first parser, which includes a number of values, each representing corresponding low-level features identified in the file. A high-level feature vector is created, which includes a number of values, each representing corresponding high-level features identified in the file. The method then creates, during a training workflow of a neural network model, a similarity space comprising embedding vectors each corresponding to the respective pair of feature vectors for each of the files. The proximity of any two of the embedding vectors in the similarity space is based on a proximity of respective high-level feature vectors for a corresponding two files.

### TECHNICAL FIELD

Embodiments of the present disclosure relate to digital computing systems, particularly with respect to assessing or evaluating whether a file is similar to one or more other files in a corpus of files.

### BACKGROUND

Digital security exploits that steal or destroy resources, data, and private information on computing devices are a problem. Governments and businesses devote significant resources to preventing intrusions and thefts related to such digital security exploits. Some of the threats posed by security exploits are of such significance that they are described as cyber terrorism or industrial espionage.

Security threats come in many forms, including computer viruses, worms, trojan horses, spyware, keystroke loggers, adware, ransomware, coin miners, and rootkits. Such security threats may be delivered through a variety of mechanisms, such as spearfishing emails, clickable links, documents, executable files, or archives. Other types of security threats may be posed by malicious actors who gain access to a computer system and attempt to access, modify, or delete information without authorization. With many of these threats, one or more files containing malicious code can be downloaded or otherwise installed on a computing device, or an existing one or more files on the computing device can be modified to include malicious code. Sometimes, the file contents, file names, file types, or file extensions of the files that contain source or executable code, malicious or otherwise, may be modified so that it is not readily apparent what the files contain.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture of a security network in which embodiments of the present disclosure may be used.

FIG. 2 illustrates a flowchart of a method to construct a similarity space according to example embodiments of the present disclosure.

FIG. 3 illustrates a flowchart of certain aspects of a method to construct a similarity space according to example embodiments of the present disclosure.

FIG. 4 illustrates a flowchart of certain aspects of a method to construct a similarity space according to example embodiments of the present disclosure

FIG. 5 illustrates a flowchart of a method to query a similarity space according to example embodiments of the present disclosure.

FIG. 6 illustrates a block diagram of certain aspects of a method to construct a similarity space according to example embodiments of the present disclosure.

### DETAILED DESCRIPTION

A similarity space defines a point of view regarding similarity between objects, such as similarity between files or the contents, aspects, or features thereof. One similarity space may adjudicate two files as similar or not based on the similarity, or not, of one set of features for the two files. For example, the similarity space may consider two files similar based on a comparison of a first set of features, e.g., low-level features, for the two files, such as how and when the files were constructed or modified. Such low-level information may be obtained from metadata associated with the files. Another similarity space may adjudicate the same two files as similar or not based on the similarity, or not, of a second, different, set of features for the two files. For example, the other similarity space may consider two files similar based on a comparison of high-level features for the two files, such as the run-time behavior of the files, or whether the files belong to the same family or type of files. For example, the other similarity space may consider two files similar if, when the files are executed, they operate in a similar manner, whether maliciously, as in the case of computer viruses, worms, trojan horses, spyware, keystroke loggers, adware, ransomware, coin miners, and rootkits, etc., or in a benign manner. Such high-level information may be obtained from descriptive tags, or simply “tags”, another form of metadata associated with each file that identify specific types of runtime behavior for the file, whether that runtime behavior is malicious, anomalous, or benign, or that identify a family or category of files of which the file is a member.

One similarity space is not necessarily better than another similarity space. One similarity space is not necessarily right while the other similarity space is wrong. There may be no objectively best similarity space. The structure or paradigm of a particular similarity space is simply a function of a chosen point of view, which may be determined, for example, by a particular use case.

That said, a malicious actor or malicious software may manipulate a file in such a manner that a machine learning classifier may be fooled in adjudicating the manipulated file and the original file or files similar to the original file as either similar when they are not (a “false positive” result), or not similar when they are (a “false negative” result), based on a comparison of one set of features (e.g., low-level features) for the files. For example, assume the original file contains malicious code, such as ransomware, and the machine learning classifier identifies the file as known ransomware based on low-level features for the file that indicate the file is indeed ransomware. A malicious actor or malicious software may copy and rename the file, and then modify it, for example, by wrapping or packing or interspersing the malicious code in the renamed file with benign or inert code. As an example, benign or inert code is code that does not execute or otherwise does not change the runtime behavior or family membership of the file, so the renamed file still contains ransomware that causes significant problems when the file is executed, plus the benign or inert code. However, packing the renamed file with benign code, in this example, changes the low-level features for the renamed file such that when the machine learning classifier compares the low-level features for the renamed file with the low-level features of the known ransomware file or other ransomware files in the same family or category, it fails to adjudicate the renamed file as ransomware. In this manner, the malicious actor/malicious software fools a machine learning classifier that operates on a given vector space, which fails to detect the renamed file as ransomware. In other words, the classifier produces a false negative result when comparing the renamed file to the original file or other, similar, ransomware files.

Conversely, a malicious actor or malicious software may manipulate a file in such a manner that another machine learning classifier may not be fooled in adjudicating the manipulated file and the original file or files in the same family as the original file as either similar when they are not (a “false positive” result), or not similar when they are (a “false negative” result), based on a comparison of another set of features (e.g., high-level features) for the files. Continuing with the above example, assume the original file contains malicious code, such as ransomware, and the other machine learning classifier identifies the file as known ransomware based on high-level features for the file that indicate the file is indeed ransomware. A malicious actor or malicious software may copy and rename the file, and then modify it in the same manner, for example, by wrapping or packing or interspersing the malicious code in the renamed file with benign code. Even though packing the renamed file with benign code changes the low-level features for the renamed file, the other machine learning classifier compares the high-level features for the renamed file with the high-level features of the known ransomware file or other files in the same family, and accurately adjudicates the renamed file as ransomware. In this manner, the malicious actor/malicious software fails to fool the machine language classifier, which successfully detects the renamed file as ransomware.

Embodiments subsequently described herein remediate the false positive results and/or the false negative results that may occur when a malicious actor or malicious software manipulates a file in such a manner that one or another machine learning classifier may be fooled in adjudicating the manipulated file as either similar to the original file when they are not (the “false positive” result), or not similar to the original file (or files in the same family) when they are (the “false negative” result), based solely on a comparison of one set of features (e.g., low-level features, or high-level features, but not both) for the files. This is accomplished by constructing an additional similarity space that compares two sets of features (e.g., both low-level features and high-level features) for the files. In particular, the similarity space may be constructed to consider any two files similar or not based on a comparison of low-level features for the two files, such as how and when the files were constructed. The similarity space may then be adjusted or transformed based on a comparison of high-level features for the two files, such as the run-time behavior of the files, or membership of the two files in a particular family or category of files. Thus, a suite of similarity spaces is provided each defining a point of view regarding similarity between objects, such as similarity between files or the contents, aspects, or features thereof. One similarity space in the suite may adjudicate two files as similar or not based on the similarity, or not, of one set of features for the two files, while another similarity space in the suite may adjudicate two files as similar or not based on the similarity, or not, of a different set of features for the two files, and yet another similarity space in the suite may adjudicate two files as similar or not based on the similarity, or not, of the one set of features, which may be informed, revised, adjusted or transformed by the similarity, or not, of the different set of features for the two files. In the latter example, if the similarity space is well constructed then the locations of files in that similarity space are determined by both sets of features, such as the low-level features and the high-level features. If a malicious actor were to perturb an original file by adding benign code, according to the embodiments described herein, the manipulated file, while it may move quite a distance from the original file in the similarity space that considers only low-level features, the manipulated file should move a much smaller distance in the similarity space that considers the low-level features but that is also informed by the high-level (human understandable) features.

As subsequently described, embodiments of the present disclosure provide a method for constructing a similarity space in which to compare files, for example, to determine if a specific file is likely malicious or benign. The method digests many files and creates a pair of feature vectors for each of the received files. For example, the method creates a low-level feature vector for a file, via a first parser. The low-level feature vector includes a number of values, each representing a corresponding one of a number of low-level features identified in the file. The method also creates a high-level feature vector, via a second parser. The high-level feature vector includes a number of values, each representing a corresponding one of a number of high-level features identified in the file. The method then creates, during a training workflow of a neural network model, a similarity space comprising a number of embedding vectors or embedding representation values each corresponding to the respective pair of feature vectors for each of the received files, wherein a proximity of any two of the number of embedding vectors in the similarity space is based at least in part on a proximity of respective high-level feature vectors for a corresponding two of the received files. Any two files may be adjudicated as similar, or not, depending on the proximity of the corresponding two embedding vectors in the similarity space, which, in turn, is based on a proximity of respective high-level feature vectors for the two files.

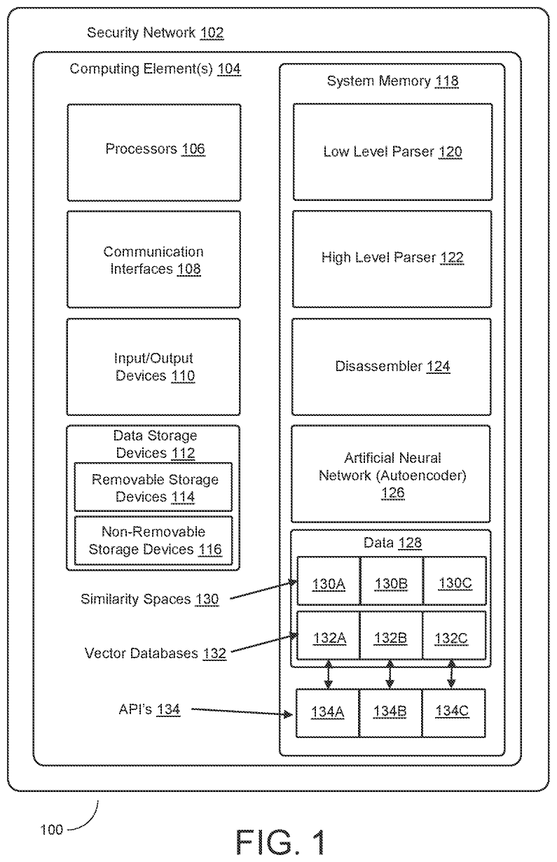

FIG. 1 depicts an example of a distributed security system 100 for instance within a cloud computing environment associated with the distributed security system 100. The distributed security system 100 includes a security network 102 in which embodiments of the present disclosure may be deployed. The security network 102 can include distributed instances of a computing element 104 that can execute instances of computer code to process data as described herein. The instances of computing element 104 can include or be one or more computing devices, such as a workstation, a personal computer (PC), a server or server farm, multiple distributed server farms, a mainframe, virtualized computing elements, or any other sort of computing device or computing devices or combinations thereof. In some examples, a computing element 104 can be a computing device, component, or system that is embedded or otherwise incorporated into another device or system. In some examples, the computing element 104 can also be a standalone or embedded component that processes or monitors incoming and/or outgoing data communications, via, for example, one or more communication interfaces 108. For example, the computing element 104 can be a network firewall, network router, network monitoring component, a supervisory control and data acquisition (SCADA) component, or any other component. In some examples, computing element(s) 104 of the security network 102 can be operated by, or be associated with, a cloud computing service provider, or a security service provider, that manages and/or operates the distributed security system 100.

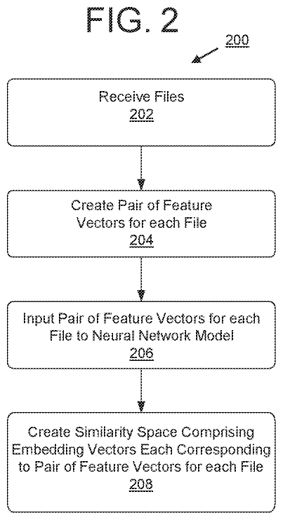

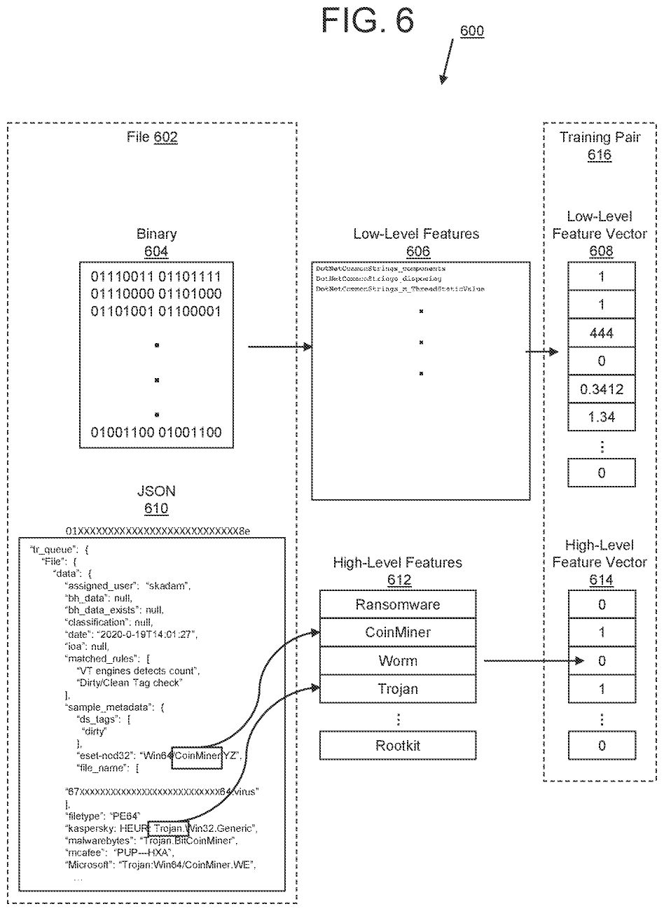

FIG. 2 is a flowchart of a process 200 for creating a similarity space by which to compare objects, such as files, based on features or aspects of the files. At block 202, one or more computing elements 104 gathers or receives as input many files, perhaps in the millions, hundreds of millions, or even billions, of files. At block 204, the computing element(s) create a pair of feature vectors for each file. For example, with reference to FIGS. 1, 3 and 6, a computing element 104 receives or accesses a file 602, and at block 302, identifies a set of low-level features 606 in the file 602. For example, a low-level parser 120 parses the binary representation 604 of the file 602 to identify and extract low-level features 606 about file 602. As an example, the Portable Execution scan (pescan) command-line tool that runs on Windows, Linux and Mac OS-X, available from TZWorks LLC, can be used as a low-level parser. Pescan scans portable executable (PE) files and identifies how they were constructed and if they are considered abnormal (e.g., different than Microsoft built PE files). Various metadata is parsed to identify such features as a compile timestamp, a MACB (modification, access, MFT (master file table) record change, birth/creation) timestamp, file size and type of executable, target OS and whether binary 604 is 32- or 64-bit, linker version used, entry point address and desired image base address, whether an X509 certificate was used and who is the author, whether there is a checksum present and does it match the binary 604, analysis of the PE internals to generate an abnormality score which compares the internal construction to the standard operating system files (higher scores equate to larger differences), and message-digest 5 (MD5) and/or Secure Hash Algorithm-1 (SHA-1) hashes of the file 602 can be generated as part of the scan. Next, at block 304, computing element 104 creates a low-level feature vector 608 based on the low-level features 606. The low-level feature vector may be a simple array in which each entry in the array is assigned a numerical value, such as a floating-point numerical value, that represents a respective low-level feature 606 extracted from the binary representation 604 of file 603, as depicted in embodiment 600 of FIG. 6.

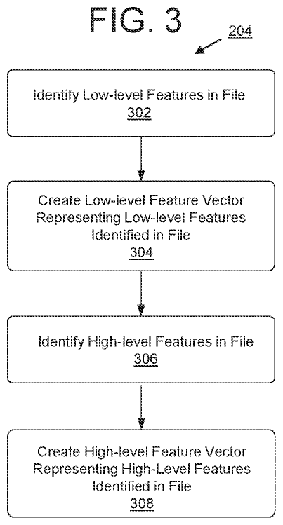

Further with reference to FIGS. 1, 3 and 6, a computing element 104 having accessed file 602, at block 306, then identifies and extracts a set of high-level features 612 in the file 602. These high-level features can inform how a file behaves at run-time, or whether the file belongs to a certain family or category of files, such as coin miner files, or ransomware. For example, a high-level parser 122 parses a JavaScript Object Notation (JSON) formatted document 610 containing descriptive tags about file 602 to identify and extract high-level features 612 about the file 602. As an example, the descriptive tags comprise information about viruses with which the file may be infected or associated, such as a trojan horse virus, or information about cryptocurrency mining software (“coin miners”). The descriptive tags may be generated by datahound tags, software that analyzes the file, or input by security threat researchers and analysts, data scientists, and cybersecurity protection service providers. Next, at block 308, computing element 104 creates a high-level feature vector 614 based on the high-level features 612 extracted from the JSON 610. The high-level feature vector 614 may be a simple array in which each entry in the array is assigned a Boolean value of zero or one, wherein a zero represents the absence of a descriptive tag, or represents a descriptive tag assigned a null value, that is associated with a particular high-level feature 612, such as a descriptive tag associated with whether the file 602 is or contains ransomware. Conversely, an entry in the array may be assigned a Boolean value of one that represents the presence of a descriptive tag associated with a particular high-level feature 612, such as a descriptive tag associated with whether the file contains coin miner software or a trojan horse virus. Computing element(s) 104 repeat the process described with respect to FIG. 3 for each file, creating at block 204 a training pair of feature vectors 616, each training pair of feature vectors 616 comprising a first feature vector, for example, a low-level feature vector 608, and a second feature vector different than the first feature vector, for example, a high-level feature vector 614, for every file received at block 202.

Once the training pairs of feature vectors 616 have been generated at block 204 for all the files received at block 202, the computing element(s) 104 inputs at block 206 the pairs of feature vectors 616 to an artificial neural network (ANN) model (or simply “ANN”) 126. The ANN 126, during a training workflow, receives the training data, that is, the pairs of feature vectors 616, each pair comprising first feature vector and a second feature vector, for example, a low-level feature vector 608 and a high-level feature vector 614, for every file received at block 202, and performs non-linear dimensionality reduction on the training data to create, at block 208, an embedding space, also known as a latent space or latent feature space. The embedding space is given by a hidden layer in the ANN 126. The embedding space comprises embedding vectors, i.e., embedding representation values-corresponding to the pairs of feature vectors 616, wherein each embedding vector corresponds to a respective pair of feature vectors 616. A similarity space, e.g., similarity space 130A, is defined by this embedding space.

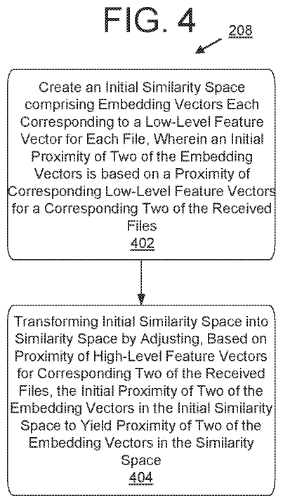

In one example of the similarity space 130A, the ANN 126 is a map that transforms initial feature vectors into their respective embedded vectors, the proximity of any pair of embedded vectors being defined by a distance metric for the embedding space. In one example embodiment, with reference to FIG. 4, this is accomplished by the ANN 126 creating, at block 402, an initial or preliminary or draft similarity space 130′ comprising embedding vectors each corresponding to a low-level feature vector 608 for each file 602, wherein an initial or preliminary proximity of any two embedding vectors in the initial similarity space 130A′ is based on a proximity of corresponding low-level feature vectors 608 for a corresponding two files 602. Then, at block 404, the ANN 126 transforms or adjusts the initial similarity space 130A′ into similarity space 130A based on the proximity of corresponding high-level feature vectors 614 for the corresponding two files 602. In particular, the ANN 126 adjusts the initial proximity of any two embedding vectors in the initial similarity space 130A′ (which was based on the proximity of corresponding low-level feature vectors 608 for a corresponding two files 602) according to or based on the proximity of corresponding high-level feature vectors 614 for the corresponding two files 602. In this manner, the proximity of corresponding high-level feature vectors 614 for the corresponding two files 602 informs the proximity of any two embedding vectors in the similarity space 130A.

According to one example embodiment, the proximity of corresponding high-level feature vectors 614 for the corresponding two files 602 approximates a distance between the respective high-level feature vectors 614 for the corresponding two files 602. There are various ways such distance may be measured or calculated. For example, the distance may be a measure of hamming loss based on a number of differing descriptor tag values for two high-level feature vectors, as given by the following equation number 1:

$$Hamming Loss = \frac{1}{N} {\sum }_{k = 1}^{N} \vert {T}_{i} Δ {T}_{j} \vert . \qquad 1$$

As another example, the distance may be a measure of Jaccard ratio based on the number of descriptor tag values that are the same among two high-level feature vectors 614, as given by the following equation number 2:

$$Jaccard = \frac{\vert {T}_{i} ⋂ {T}_{j} \vert}{\vert {T}_{i} ⋃ {T}_{j} \vert} . \qquad 2$$

As yet another example, the distance may be a measure of the mean square error (MSE) over the descriptor tag values for two high-level feature vectors 614, as given by the following equation number 3:

$$M S E = \frac{1}{N} {\sum }_{k = 1}^{N} {( {T}_{i} - {T}_{j} )}^{2} . \qquad 3$$

So then, the total loss for the ANN 126, which is typical for an autoencoder, is the reconstruction loss plus the distance loss, as given in the following equation (using hamming loss in this example):

$$Total Loss = reconstruction\_loss + distance\_loss = {‖ {X}_{i} - {\hat{X}}_{i} ‖}^{2} + {‖ {X}_{j} - {\hat{X}}_{j} ‖}^{2} + ‖ \frac{1}{N} {\sum }_{k = 1}^{N} \vert {T}_{i} Δ {T}_{j} \vert - {‖ emb ( {X}_{i} ) - emb ( {X}_{j} ) ‖}^{2} ‖$$

An autoencoder is a type of artificial neural network used to learn efficient codings of unlabeled data (unsupervised learning). The encoding is validated and refined by attempting to regenerate the input from the encoding. The autoencoder learns a representation (encoding) for a set of data, typically for dimensionality reduction, by training the network to ignore insignificant data (“noise”).

As mentioned above, in one example embodiment, with reference to FIG. 4, the ANN 126 creates, at block 402, the initial similarity space 130A′ comprising embedding vectors each corresponding to the low-level feature vector 608 for each file 602 and calculates the initial proximity of any two embedding vectors in the initial similarity space 130A′ based on the proximity of corresponding low-level feature vectors 608 for the corresponding two files 602. In one example, that initial proximity of any two embedding vectors in the initial similarity space 130A′ approximates a Euclidian distance between the two embedding vectors in the initial similarity space 130A′. Similarly, the ANN 126 transforms, at block 404, the initial similarity space 130A′ into similarity space 130A based on the proximity of corresponding high-level feature vectors 614 for the corresponding two files 602. In particular, the ANN 126 adjusts the initial proximity of any two embedding vectors in the initial similarity space 130A′ based on a distance between corresponding high-level feature vectors 614 for the corresponding two files 602. Thus, in one example, the ANN 126 adjusts the Euclidian distance between any two embedding vectors in the initial similarity space 130A′ based on a distance between corresponding high-level feature vectors 614 for the corresponding two files 602. This yields the similarity space 130A in which the distance between any two embedding vectors in the similarity space 130A is informed by the distance between corresponding high-level feature vectors 614 for the corresponding two files 602. In this manner, the proximity of corresponding high-level feature vectors 614 for the corresponding two files 602 informs the proximity of any two embedding vectors in the similarity space 130A.

As discussed above, one similarity space may adjudicate two files as similar or not based on the similarity, or not, of one, or multiple sets of features for the two files. In the similarity space 130A, both low-level 608 and high-level features 614 are considered in comparing the similarity or not between two files. Computing element 104 may optionally maintain one or more additional similarity spaces that provide different points of view in terms of similarity of files. For example, the similarity space 130B may consider two files similar based on a comparison of low-level features 608 for the two files, such as how and when the files were constructed or modified. These static features of the file may be very useful in terms of a file classification process that attempts to assess whether a file is benign or malicious before the file is executed or runs but is not optimal in terms of assessing the actual runtime behavior of files. Another similarity space 130C may adjudicate the same two files as similar or not based on the similarity, or not, of a different set of features for the two files. For example, the other similarity space may consider two files similar based on a comparison of features for the two files discovered by a disassembler 124, such as flow control similarities or dissimilarities, between the two files. A disassembler is a computer program that translates machine language into assembly language. A disassembler provides the inverse operation to that of an assembler. Disassembly, the output of a disassembler, is typically formatted for human-readability rather than suitability for input to an assembler, making it principally a reverse-engineering tool. Common uses of disassemblers include recovering source code of a program whose original source was lost, understanding the functions of malicious code, or modifying software (such as ROM hacking), and software cracking.

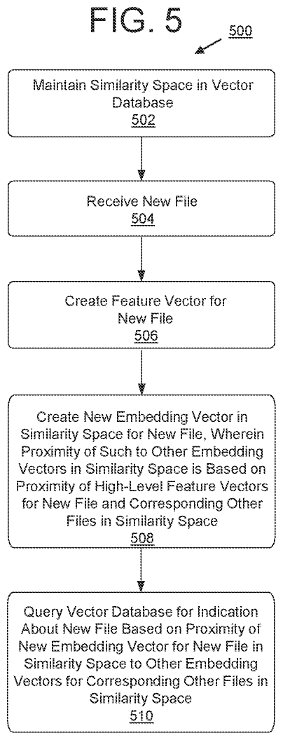

According to one embodiment 500, with reference to FIG. 5, this suite of similarity spaces 130A, 130B and 130C may be made available to users at block 502 by leveraging a corresponding suite 132 of vector databases 132A, 132B and 132C. Each vector database is a fully managed solution for storing, indexing, and searching across an extremely large dataset of unstructured data that leverages the power of the embeddings from machine learning models. These vector databases 132A, 132B and 132C provide fast querying and searching of the similarity spaces 130A, 130B and 130C, at scale by solving the O(n²) Nearest Neighbors Search Problem. In one example, the vector databases 132 are maintained by a cloud computing service provider and made available to users via a respective suite of APIs 134, including APIs 134A, 134B and 134C. A user can now input any number of news files at block 504 to computing element 104. Computing element 104 creates at block 506 one or more feature vectors for each new file, in the manner described above with reference to relevant portions of FIGS. 2, 3, and 6. Appropriate embedding vectors are then created for one or more of similarity spaces 130A, 130B, 130C during an inference workflow of the neural network model. For example, during the inference workflow of the neural network model, embedding vectors are created at block 508 for similarity space 130A for the new files, wherein the proximity of these embedding vectors to other embedding vectors in similarity space 130A is based on the proximity of the high-level feature vectors 614 for the new files 602 and corresponding other files in similarity space 130A. A user can then query, at block 510, the vector database 132A via API 134A for an indication about a new file (e.g., does the file contain ransomware, or a trojan horse virus?) based on the proximity of the embedding vector associated with the new file in the similarity space 130 to other embedding vectors for corresponding other files in the similarity space 130. In other words, a user can query whether the new file is similar to other files in the similarity space based on the proximity of the embedding vectors of the new file and other files. Similar may be defined, for example, as files in the similarity space being within an epsilon radius of the new file, the value of which can be configurable.

As mentioned above, FIG. 1 depicts an example distributed security system 100 including a security network 102 and one or more instances of computing elements 104. A computing element 104 can be one or more computing devices, such as a workstation, a personal computer (PC), an embedded system, a server or server farm, multiple distributed server farms, a mainframe, or any other type of computing device. As shown in FIG. 1, a computing element 104 can include processor(s) 106, system memory 118, communication interface(s) 108, input/output devices 110, and one or more data storage devices 112, including one or more removable storage devices 114 and one or more non-removable storage devices 116. The one or more removable storage devices 114 or the one or more non-removable storage devices 116 can include a machine readable medium on or in which to store computer code that when executed carries out the methods described herein.

In various examples, the processor(s) 106 can be a central processing unit (CPU), a graphics processing unit (GPU), or both CPU and GPU, or any other type of processing unit. Each of the one or more processor(s) 106 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 106 may also be responsible for executing drivers and other computer-executable instructions for applications, routines, or processes stored in the system memory 118, which can be associated with common types of volatile (RAM) and/or nonvolatile (ROM) memory.

In various examples, the system memory 118 can include volatile memory (such as RAM), non-volatile memory (such as ROM, flash memory, etc.) or some combination of the two. System memory 118 can further include non-transitory computer-readable media, such as volatile and nonvolatile, removable and non-removable media implemented in any method or technology for storage of information, such as computer-readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store information accessed by the computing element 104. Any such non-transitory computer-readable media may be part of the computing element 104.

The system memory 118 can store data, including computer-executable instructions for parsers such as low-level parser 120, high-level parser 122, for the disassembler 124, and for one or more artificial neural networks 126, such as an autoencoder, as described herein. The system memory 118 can further store data 128 or any other modules being processed and/or used by one or more components of computing element 104, including the low-level parser 120, high-level parser 122, disassembler 124, and artificial neural network 126. For example, the memory can store as data 128 a suite of similarity spaces 130, including as examples separate similarity spaces 130A. 130B, and 130C. The system memory 118 can also store as data a suite of vector databases 132, including as examples separate vector databases 132A, 132B and 132C, each of which has access to a corresponding similarity space, and which in turn can be accessed by modules such as a suite of application programmatic interfaces (APIs) 134 including API 134A, 134B and 134C.

The system memory 118 can also store any other modules and data that can be utilized by the computing element 104 to perform or enable performing any action taken by the computing element 104. For example, the modules and data can include a platform, operating system, and/or applications, as well as data utilized by the platform, operating system, and/or applications.

The communication interfaces 108 can link the computing element 104 to other elements in security network 102 through wired or wireless connections. For example, communication interfaces 108 can be wired networking interfaces, such as Ethernet interfaces or other wired data connections, or wireless data interfaces that include transceivers, modems, interfaces, antennas, and/or other components, such as a Wi-Fi interface. The communication interfaces 108 can include one or more modems, receivers, transmitters, antennas, interfaces, error correction units, symbol coders and decoders, processors, chips, application specific integrated circuits (ASICs), programmable circuit (e.g., field programmable gate arrays), software components, firmware components, and/or other components that enable the computing element 104 to send and/or receive data, for example to exchange or provide access to data 128, and/or any other data with the security network 102.

The input/output devices 110 can include one or more types of output devices, such as speakers or a display, such as a liquid crystal display. The output devices can also include ports for one or more peripheral devices, such as headphones, peripheral speakers, and/or a peripheral display. In some examples, a display can be a touch-sensitive display screen, which can also act as an input device. Input devices can include one or more types of input devices, such as a microphone, a keyboard or keypad, and/or a touch-sensitive display, such as the touch-sensitive display screen described above.

The data storage devices 512 can store one or more sets of computer-executable instructions, such as software or firmware, that embodies any one or more of the methodologies or functions described herein. The computer-executable instructions can also reside, completely or at least partially, within the processor(s) 106, system memory 118, and/or communication interface(s) 108 during execution thereof by the computing element 104. The processor(s) 106 and the system memory 118 can also constitute machine readable media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, may perform operations described above with reference to FIGS. 2-6. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

What is claimed is:

1. A method, comprising:
receiving a plurality of files;
creating a respective pair of feature vectors for each of the received plurality of files, comprising:
creating, via a first parser, a low-level feature vector comprising a first plurality of values, each representing a corresponding one of a plurality of low-level features identified in the file; and
creating, via a second parser, a high-level feature vector comprising a second plurality of values, each representing a corresponding one of a plurality of high-level features identified in the file; and
creating, during a training workflow of a neural network model, a similarity space comprising a plurality of embedding vectors each corresponding to the respective pair of feature vectors for each of the received plurality of files, wherein a proximity of two of the plurality of embedding vectors in the similarity space is based on a proximity of respective high-level feature vectors for a corresponding two of the received plurality of files.

2. The method of claim 1, further comprising:
identifying, via the first parser, the plurality of low-level features in the file; and
identifying, via the second parser, the plurality of high-level features in the file.

3. The method of claim 1, further comprising:
storing the similarity space comprising the plurality of embedding vectors in a vector database;
receiving a new file;
creating a feature vector for the new file, comprising a plurality of low-level features in the new file;
computing, during an inference workflow of the neural network model, a new embedding vector in the similarity space corresponding to the feature vector for the new file, wherein a proximity of the new embedding vector to any one of the plurality of embedding vectors in the similarity space is based on a proximity of the feature vectors for the new file and a corresponding any one of the received plurality of files; and
querying the vector database to output an indication about the new file based on the proximity of the new embedding vector for the new file in the similarity space to the plurality of embedding vectors for the received plurality of files in the similarity space.

4. The method of claim 1, wherein creating, during the training workflow of the neural network model, the similarity space comprising the plurality of embedding vectors each corresponding to the respective pair of feature vectors for each of the received plurality of files, wherein the proximity of two of the plurality of embedding vectors in the similarity space is based on the proximity of respective high-level feature vectors for the corresponding two of the received plurality of files, comprises:
creating, during the training workflow of the neural network model, an initial similarity space comprising the plurality of embedding vectors each corresponding to a respective low-level feature vector for each of the received plurality of files, wherein an initial proximity of two of the plurality of embedding vectors in the initial similarity space is based on a proximity of the corresponding low-level feature vectors for a corresponding two of the received plurality of files; and
transforming the initial similarity space into the similarity space by adjusting, based on the proximity of the respective high-level feature vectors for the corresponding two of the received plurality of files, the initial proximity of two of the plurality of embedding vectors in the initial similarity space to yield the proximity of two of the plurality of embedding vectors in the similarity space.

5. The method of claim 1, wherein the proximity of the respective high-level feature vectors for the corresponding two of the received plurality of files approximates a distance between the respective high-level feature vectors for the corresponding two of the received plurality of files.

6. The method of claim 5, wherein the distance between the respective high-level feature vectors for the corresponding two of the received plurality of files is based on one of a hamming loss, a Jaccard ratio, and a mean square error (MSE), calculated for the respective high-level feature vectors for the corresponding two of the received plurality of files.

7. The method of claim 4, wherein the initial proximity of two of the plurality of embedding vectors in the initial similarity space approximates a Euclidian distance between the two of the plurality of embedding vectors in the initial similarity space; and
wherein transforming the initial similarity space into the similarity space by adjusting, based on the proximity of the respective high-level feature vectors for the corresponding two of the received plurality of files, the initial proximity of two of the plurality of embedding vectors in the initial similarity space to yield the proximity of two of the plurality of embedding vectors in the similarity space comprises adjusting, based on the proximity of the respective high-level feature vectors for the corresponding two of the received plurality of files, the Euclidian distance between the two of the plurality of embedding vectors in the initial similarity space to yield the proximity of two of the plurality of embedding vectors in the similarity space.

8. A computer system, comprising:
one or more processors;
a memory to store computer-executable instructions that, when executed by the one or more processors, cause the one or more processors to perform operations comprising:
receiving a plurality of files;
creating a respective pair of feature vectors for each of the received plurality of files, comprising:
creating, via a first parser, a low-level feature vector comprising a first plurality of values, each representing a corresponding one of a plurality of low-level features identified in the file; and
creating, via a second parser, a high-level feature vector comprising a second plurality of values, each representing a corresponding one of a plurality of high-level features identified in the file; and
creating, during a training workflow of a neural network model, a similarity space comprising a plurality of embedding vectors each corresponding to the respective pair of feature vectors for each of the received plurality of files, wherein a proximity of two of the plurality of embedding vectors in the similarity space is based on a proximity of respective high-level feature vectors for a corresponding two of the received plurality of files.

9. The computer system of claim 8, further comprising:
identifying, via the first parser, the plurality of low-level features in the file; and
identifying, via the second parser, the plurality of high-level features in the file.

10. The computer system of claim 8, further comprising:
storing the similarity space comprising the plurality of embedding vectors in a vector database;
receiving a new file;
creating a feature vector for the new file, comprising a plurality of low-level features in the new file;
computing, during an inference workflow of the neural network model, a new embedding vector in the similarity space corresponding to the feature vector for the new file, wherein a proximity of the new embedding vector to any one of the plurality of embedding vectors in the similarity space is based on a proximity of the feature vector for the new file and a corresponding any one of the received plurality of files; and
querying the vector database to output an indication about the new file based on the proximity of the new embedding vector for the new file in the similarity space to the plurality of embedding vectors for the received plurality of files in the similarity space.

11. The computer system of claim 8, wherein creating, during the training workflow of the neural network model, the similarity space comprising the plurality of embedding vectors each corresponding to the respective pair of feature vectors for each of the received plurality of files, wherein the proximity of two of the plurality of embedding vectors in the similarity space is based on the proximity of respective high-level feature vectors for the corresponding two of the received plurality of files, comprises:
creating, during the training workflow of the neural network model, an initial similarity space comprising the plurality of embedding vectors each corresponding to a respective low-level feature vector for each of the received plurality of files, wherein an initial proximity of two of the plurality of embedding vectors in the initial similarity space is based on a proximity of the corresponding low-level feature vectors for a corresponding two of the received plurality of files; and
transforming the initial similarity space into the similarity space by adjusting, based on the proximity of the respective high-level feature vectors for the corresponding two of the received plurality of files, the initial proximity of two of the plurality of embedding vectors in the initial similarity space to yield the proximity of two of the plurality of embedding vectors in the similarity space.

12. The computer system of claim 8, wherein the proximity of the respective high-level feature vectors for the corresponding two of the received plurality of files approximates a distance between the respective high-level feature vectors for the corresponding two of the received plurality of files.

13. The computer system of claim 12, wherein the distance between the respective high-level feature vectors for the corresponding two of the received plurality of files is based on one of a hamming loss, a Jaccard ratio, and a mean square error (MSE), calculated for the respective high-level feature vectors for the corresponding two of the received plurality of files.

14. The computer system of claim 11, wherein the initial proximity of two of the plurality of embedding vectors in the initial similarity space approximates a Euclidian distance between the two of the plurality of embedding vectors in the initial similarity space; and
wherein transforming the initial similarity space into the similarity space by adjusting, based on the proximity of the respective high-level feature vectors for the corresponding two of the received plurality of files, the initial proximity of two of the plurality of embedding vectors in the initial similarity space to yield the proximity of two of the plurality of embedding vectors in the similarity space comprises adjusting, based on the proximity of the respective high-level feature vectors for the corresponding two of the received plurality of files, the Euclidian distance between the two of the plurality of embedding vectors in the initial similarity space to yield the proximity of two of the plurality of embedding vectors in the similarity space.

15. One or more non-transitory computer-readable media storing computer-executable instructions that, when executed by one or more processors, cause the one or more processors to perform operations comprising:
receiving a plurality of files;
creating a respective pair of feature vectors for each of the received plurality of files, comprising:
creating, via a first parser, a first feature vector comprising a first plurality of values, each representing a corresponding one of a plurality of first features identified in the file; and
creating, via a second parser, a second feature vector comprising a second plurality of values, each representing a corresponding one of a plurality of second features different than the plurality of first features identified in the file; and
creating, during a training workflow of a neural network model, a similarity space comprising a plurality of embedding vectors each corresponding to the respective pair of feature vectors for each of the received plurality of files, wherein a proximity of two of the plurality of embedding vectors in the similarity space is based on a proximity of respective second feature vectors for a corresponding two of the received plurality of files.

16. The one or more non-transitory computer-readable media of claim 15, further comprising computer-executable instructions that, when executed by one or more processors, cause the one or more processors to perform operations comprising:
storing the similarity space comprising the plurality of embedding vectors in a vector database;
receiving a new file;
creating a feature vector for the new file, comprising a plurality of first features in the new file;
computing, during an inference workflow of the neural network model, a new embedding vector in the similarity space corresponding to the feature vector for the new file, wherein a proximity of the new embedding vector to any one of the plurality of embedding vectors in the similarity space is based on a proximity of the feature vectors for the new file and a corresponding any one of the received plurality of files; and
querying the vector database to output an indication about the new file based on the proximity of the new embedding vector for the new file in the similarity space to the plurality of embedding vectors for the received plurality of files in the similarity space.

17. The one or more non-transitory computer-readable media of claim 15, wherein creating, during the training workflow of the neural network model, the similarity space comprising the plurality of embedding vectors each corresponding to the respective pair of feature vectors for each of the received plurality of files, wherein the proximity of two of the plurality of embedding vectors in the similarity space is based on the proximity of respective second feature vectors for the corresponding two of the received plurality of files, comprises:
creating, during the training workflow of the neural network model, an initial similarity space comprising the plurality of embedding vectors each corresponding to a respective first feature vector for each of the received plurality of files, wherein an initial proximity of two of the plurality of embedding vectors in the initial similarity space is based on a proximity of the corresponding first feature vectors for a corresponding two of the received plurality of files; and
transforming the initial similarity space into the similarity space by adjusting, based on the proximity of the respective second feature vectors for the corresponding two of the received plurality of files, the initial proximity of two of the plurality of embedding vectors in the initial similarity space to yield the proximity of two of the plurality of embedding vectors in the similarity space.

18. The one or more non-transitory computer-readable media of claim 17, wherein the initial proximity of two of the plurality of embedding vectors in the initial similarity space approximates a Euclidian distance between the two of the plurality of embedding vectors in the initial similarity space; and
wherein transforming the initial similarity space into the similarity space by adjusting, based on the proximity of the respective second feature vectors for the corresponding two of the received plurality of files, the initial proximity of two of the plurality of embedding vectors in the initial similarity space to yield the proximity of two of the plurality of embedding vectors in the similarity space, comprises adjusting, based on the proximity of the respective second feature vectors for the corresponding two of the received plurality of files, the Euclidian distance between the two of the plurality of embedding vectors in the initial similarity space to yield the proximity of two of the plurality of embedding vectors in the similarity space.

19. The one or more non-transitory computer-readable media of claim 15,
wherein creating, via the first parser, the first feature vector comprising the first plurality of values, each representing the corresponding one of the plurality of first features identified in the file, comprises creating, via the first parser, a low-level feature vector comprising the first plurality of values, each representing a corresponding one of a plurality of low-level features identified in the file;
wherein creating, via the second parser, the second feature vector comprising the second plurality of values, each representing the corresponding one of the plurality of second features different than the plurality of first features identified in the file, comprises creating, via the second parser, a high-level feature vector comprising the second plurality of values, each representing a corresponding one of a plurality of high-level features identified in the file; and
wherein creating, during the training workflow of the neural network model, the similarity space comprising the plurality of embedding vectors each corresponding to the respective pair of feature vectors for each of the received plurality of files, wherein the proximity of two of the plurality of embedding vectors in the similarity space is based on the proximity of respective second feature vectors for the corresponding two of the received plurality of files, comprises creating, during the training workflow of the neural network model, the similarity space comprising the plurality of embedding vectors each corresponding to the respective pair of feature vectors for each of the received plurality of files, wherein the proximity of two of the plurality of embedding vectors in the similarity space is based on the proximity of respective high-level feature vectors for the corresponding two of the received plurality of files.

20. The one or more non-transitory computer-readable media of claim 19, wherein creating, during the training workflow of the neural network model, the similarity space comprising the plurality of embedding vectors each corresponding to the respective pair of feature vectors for each of the received plurality of files, wherein the proximity of two of the plurality of embedding vectors in the similarity space is based on the proximity of respective high-level feature vectors for the corresponding two of the received plurality of files, comprises:
creating, during the training workflow of the neural network model, an initial similarity space comprising the plurality of embedding vectors each corresponding to a respective low-level feature vector for each of the received plurality of files, wherein an initial proximity of two of the plurality of embedding vectors in the initial similarity space is based on a proximity of the corresponding low-level feature vectors for a corresponding two of the received plurality of files; and
transforming the initial similarity space into the similarity space by adjusting, based on the proximity of the respective high-level feature vectors for the corresponding two of the received plurality of files, the initial proximity of two of the plurality of embedding vectors in the initial similarity space to yield the proximity of two of the plurality of embedding vectors in the similarity space.
